(19) United States
(12) Patent Application Publication
(10) Pub. No.: US 2011/0265402 A1
(43) Pub. Date: Nov. 3, 2011

(54) System and Method for Attaching a Door Assembly to a Structure

(75) Inventor: Stefan Pfleger, Amarillo, TX (US)

(73) Assignee: ZARGES ALUMINUM SYSTEMS LLC, Amarillo, TX (US)

(21) Appl. No.: 12/773,009

(22) Filed: May 3, 2010

(51) Int. Cl. E06B 1/04; E06B 1/56

(52) U.S. Cl. 52/213; 52/745.21

(57) ABSTRACT

A system and method for attaching a door assembly to a structure is disclosed. Specifically, a doorframe system comprising a press frame and a plurality of press frame brackets is disclosed. The press frame has a first side and a second side, wherein the first side is capable of connecting to a doorframe, and the second side is capable of pressing against a structure frame. Each press frame bracket has a first end and a second end, wherein the first end is connected to the press frame.

### BACKGROUND

This disclosure relates to a system and method for attaching a door assembly to a structure. More particularly, this disclosure relates to attaching a door assembly to a structure frame using an improved press frame and brackets.

Sometimes a structure, such as a wind turbine, requires a door to be placed on the structure. Various methods exist to secure a doorframe. In one embodiment, the door assembly is welded to the structure. However, such process requires a welder, and makes the door difficult to remove. In another embodiment, the door is fastened using a steel plate system. However such system is also difficult to install and uninstall. Additionally, in such cases the material used to create the door assembly and the material to create the structure can be different. It would therefore be advantageous to implement an improved method and system for attaching a door assembly to a structure.

### SUMMARY

A system and method for attaching a door assembly to a structure is disclosed. Specifically, a doorframe system comprising a press frame and a plurality of press frame brackets is disclosed. The press frame has a first side and a second side, wherein the first side is capable of connecting to a doorframe, and the second side is capable of pressing against a structure frame. Each press frame bracket has a first end and a second end, wherein the first end is connected to the press frame.

A method of attaching a door assembly to a structure frame comprising pulling a door assembly against a structure frame is disclosed. The door assembly comprises a doorframe, a press frame, a plurality of press frame brackets, a plurality of structure frame brackets, and a plurality of tension devices. The press frame has a first side and a second side, wherein the first side is capable of connecting to a doorframe, and the second side is capable of pressing against a structure frame. The plurality of press frame brackets has a first end and a second end, wherein the first end is connected to the press frame. The plurality of structure frame brackets has a first end and a second end. The tension devices each are capable of applying a force against a structure frame in a direction towards the press frame.

A door assembly comprising a doorframe, a door, a press frame, a plurality of press frame brackets, a plurality of structure frame brackets, and a plurality of tension devices is disclosed. The press frame has a first side and a second side, wherein the first side is capable of connecting to a doorframe, and the second side is capable of pressing against a structure frame. The plurality of press frame brackets each have a first end and a second end, wherein the first end is connected to the press frame. The plurality of structure frame brackets each have a first end and a second end.

### BRIEF DESCRIPTION OF THE DRAWINGS

FIG. 1A illustrates a wind turbine comprising a structure frame.

FIG. 1B illustrates an expanded view of a tower base.

FIG. 2A illustrates a front view of door assembly.

FIG. 2B illustrates a rear view of a door assembly.

FIG. 3 illustrates a rear view of a door assembly mounted to a structure frame.

FIG. 4 illustrates a cross section of a frame bracket securing a press frame to a structure frame.

### DETAILED DESCRIPTION

Described herein is a system and method for sealing a door assembly to a structure. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

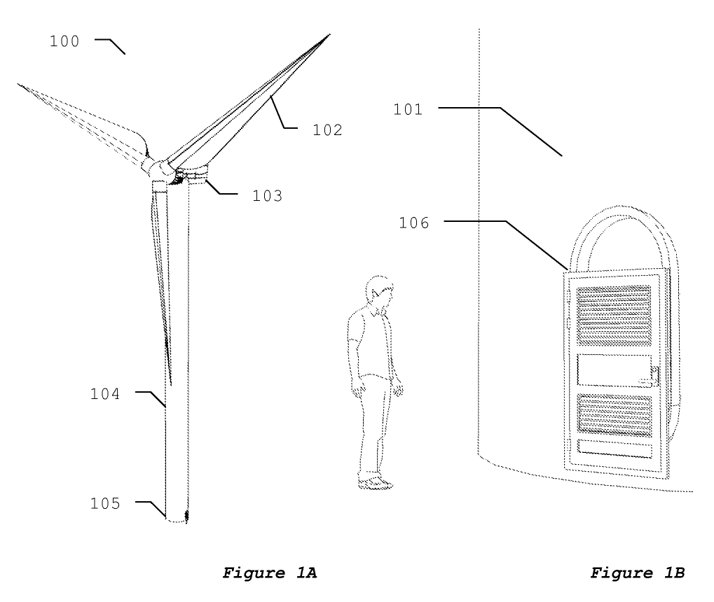

FIG. 1A illustrates a wind turbine 100 comprising a structure frame 101. Within this disclosure, a wind turbine 100 is discussed. However such discussion is merely exemplary of an apparatus with a structure frame 101, and is not intended to limit the scope of the invention to use with a wind turbine 100. Wind turbine 100 can comprise blades 102, a turbine 103 and a tower 104 that can extend downward from turbine 103 to a foundation 105. FIG. 1B illustrates an expanded view of tower 104. Tower 104 can comprise a structure frame 101. A door assembly 106 can mount to structure frame 101.

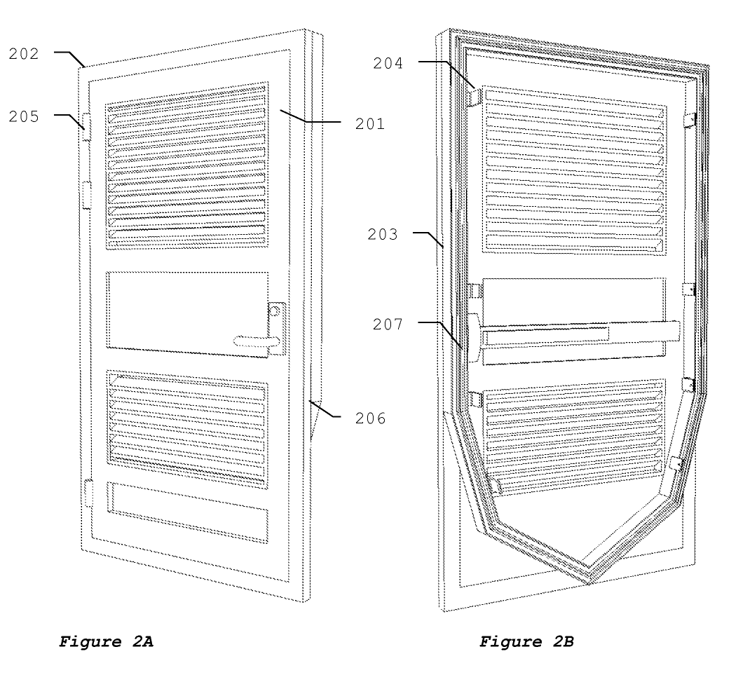

FIG. 2A illustrates a front view of door assembly 106. FIG. 2B illustrates a rear view of door assembly 106. Door assembly 106 can comprise a door 201, a doorframe 202, a press frame 203, and/or press frame brackets 204. In one embodiment, door assembly 106 can also comprise hinges 205. In such embodiment, doorframe 202 can circumscribe door 201. Hinges 205 can connect door 201 to doorframe 202 along one edge of door 201, allowing door 201 to open and close. Press frame 203 can have a press frame first side 206 that can connect to doorframe 202. Press frame 203 can also have a press frame second side 207 that can face structure frame 101. In one embodiment, press frame 203 can be substantially the same shape as doorframe 202. In another embodiment, press frame 203 can be substantially the same shape as structure frame 101. In another embodiment, press frame 203 can be substantially the same shape as an innermost shape created by overlapping doorframe 202 with structure frame 101 (for example, a convex lens shape being the innermost shape created by overlapping two circles). In another embodiment, press frame 203 is not closed form. Each press frame bracket 204 can protrude out from press frame 203. In one embodiment, each frame bracket protrudes away from press frame 203 substantially parallel to the plane of door 201 before bending to become substantially orthogonal to the plane of door 201. In such embodiment, a press frame bracket first end 206 can be against or within press frame 203, and a press frame bracket second end 207 can be substantially orthogonal to the plane of door 201.

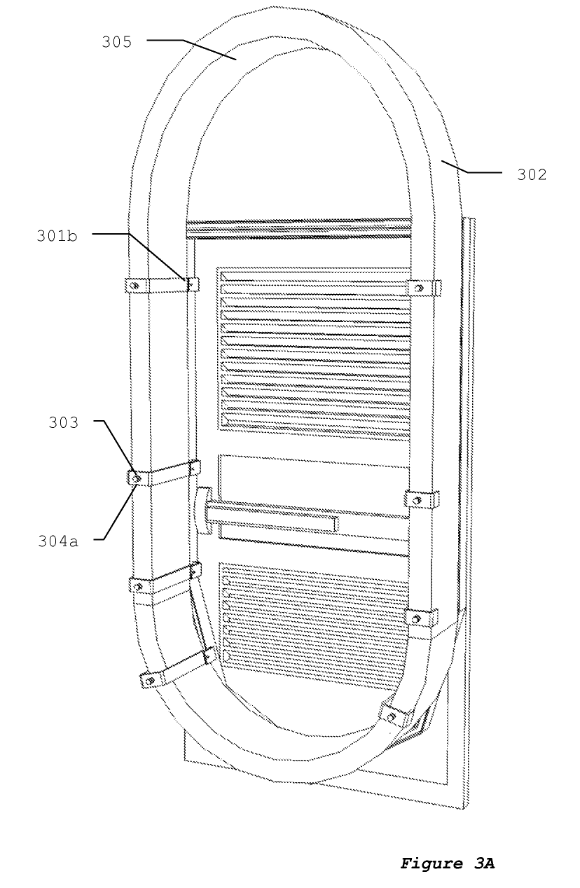

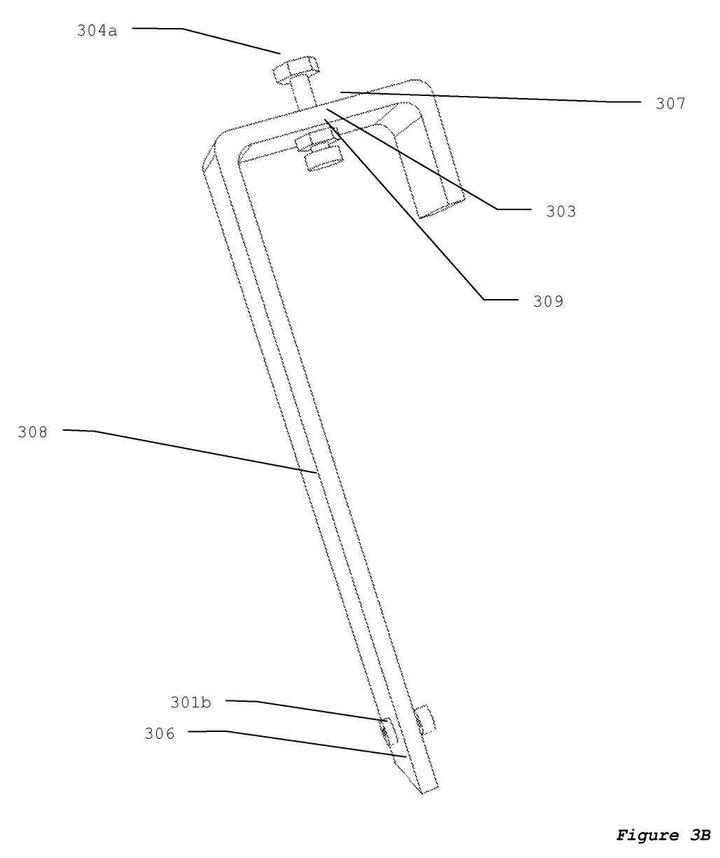

FIG. 3A illustrates a rear view of door assembly 106 mounted to structure frame 101. FIG. 3B illustrates an expanded view of structure frame bracket 308. Structure frame brace can have a structure frame bracket first end 306 and can have a structure frame bracket second end 307. To mount door assembly 106 to structure frame 101, each structure frame bracket first end 306 can connect to a press frame bracket second end 207 using a first fastener 301a. Examples of a fastener 301 can include any suitable fastener known in the art, and includes, but is not limited to nuts, bolds and rivets. Structure frame bracket 308 can extend from the connection point with press frame bracket 204, in a direction substantially parallel with a structure frame inner surface 305 and in a direction away from door 201. Upon reaching the edge of structure frame 101, frame bracket can bend around structure frame 101, maintaining it's substantial parallel relationship with structure frame 101. In one embodiment, after bending around structure frame 101 to form structure frame bracket second end 307, structure frame bracket 308 can bend once more to become parallel with an outer surface of structure frame 101. The shape of structure frame bracket second end 307 can allow it to grapple structure frame 101. An orifice 303 can exist in structure frame bracket 308 that allows a tension device 304 to be placed within press frame bracket 204, tension device 304 extending in a direction substantially orthogonal to the plane of door 201, and towards press frame 203. Such placement allows it to exert a force on structure frame, in the direction of press frame 101.

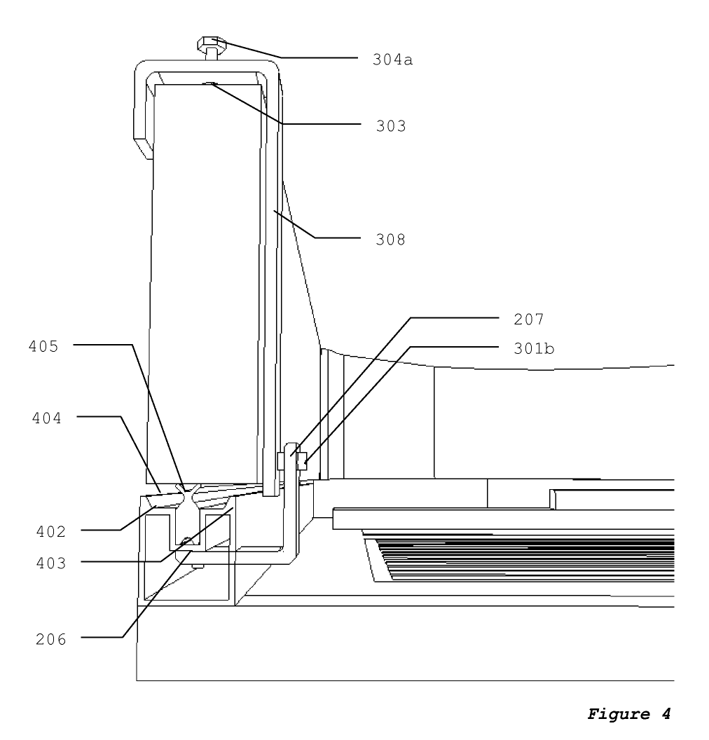

FIG. 4 illustrates a cross section of a structure frame bracket 308 securing a press frame 203 to a structure frame 101. In one embodiment, orifice 303 is threaded, and tension device 304 is a threaded fastener 304a. In another embodiment, a threaded fastener receiver 309 is placed securely within orifice 303, and tension device 304 is threaded fastener 304a. In another embodiment, threaded fastener receiver 309 is larger than orifice 303, and is placed between structure frame bracket 308 and structure frame 101. Threaded fastener 304a extends through orifice 303 and then through threaded fastener receiver to structure frame 101. In this embodiment, threaded fastener receiver 305 can be a nut, and is well known in the art. Further in one embodiment, threaded fastener 304a is blunted on an end making contact with structure frame 101.

A second fastener 301b can connect press frame bracket first end 206 to press frame 203. In each embodiment involving threaded fastener 304a, threaded fastener 304a can be screwed into threading device. As threaded fastener 304a makes contact with structure frame 101, the screwing motion pushes structure frame bracket 308 in a direction orthogonal to the plane of door 201 and away from structure frame 101. Such motion can cause tension between structure frame bracket 308 and press frame bracket 204, pulling press frame 203 towards structure frame 101 until press frame 203 presses against structure frame 101.

In one embodiment, press frame 203 can be improved to provide an improved seal between press frame 203 and structure frame 101. In one embodiment, press frame 203 forms an outer ridge 402 and an inner ridge 403. Between outer ridge 402 and inner ridge 403 can exist an indention 404. Indention 404 can be house a weather resistant material 405. An example of weather resistant material 405 is silicone. Such example is exemplary and not limiting. In one embodiment weather resistant material 405 can be in the form of a rectangular with a circular segment removed from each side, when in its non-deformed state. A first portion of weather resistant material 405 can be bent downward and placed within indention 404. A second portion of weather resistant material 405 can protrude upwards from rectangular empty space, out past outer ridge 402 and inner ridge 403, such that when press frame 203 is placed towards structure frame 101, weather resistant material 405 touches structure frame 101 before press frame 203 makes contact with structure frame 101. As press frame 203 is forced up against structure frame 101, weather resistant material 405 can further deform, while remaining pressed against structure frame 101, thereby creating a barrier.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A doorframe system comprising:
a press frame, the press frame having a first side and a second side, wherein the first side is capable of connecting to a doorframe, and the second side is capable of pressing against a structure frame and
a plurality of press frame brackets, each press frame bracket having a first end and a second end, wherein the first end is connected to the press frame.

2. The system of claim 1, further comprising a plurality of structure frame brackets, each structure frame bracket having a first end and a second end.

3. The system of claim 2, wherein the each of the structure frame bracket first ends connects to one of the plurality of press frame bracket second ends.

4. The system of claim 3, wherein the structure frame bracket second end is formed to grapple around a structure frame.

5. The system of claim 4 wherein each of the structure frame brackets comprises a tension device capable of applying a force against a structure frame in a direction towards the press frame.

6. The system of claim 5 wherein at least one of the tension devices is a threaded fastener.

7. The system of claim 6 wherein each of the frame bracket second ends comprises an orifice, and the at least one threaded fastener passes through at least one of the orifices.

8. The system of claim 7 wherein the at least one of the orifices is threaded.

9. The system of claim 6 further comprising a threaded fastener receiver.

10. A method of attaching a door assembly to a structure frame, comprising
Pulling a door assembly against a structure frame, wherein the door assembly comprises
a doorframe;
a press frame, the press frame having a first side and a second side, wherein the first side is capable of connecting to a doorframe, and the second side is capable of pressing against a structure frame;
a plurality of press frame brackets, each press frame bracket having a first end and a second end, wherein the first end is connected to the press frame; and
a plurality of structure frame brackets, each structure frame bracket having a first end and a second end; and
a plurality of tension devices, each capable of applying a force against a structure frame in a direction towards the press frame.

11. The method of claim 10, wherein pulling the door assembly against the structure includes adjusting one or more of the tension devices.

12. The method of claim 11, wherein at least one of the tension devices is a threaded fastener.

13. The method of claim 12 wherein adjusting the one or more threaded fasteners comprises screwing the threaded fastener.

14. A door assembly comprising
a doorframe;
a door;
a press frame, the press frame having a first side and a second side, wherein
the first side is capable of connecting to a doorframe, and
the second side is capable of pressing against a structure frame;
a plurality of press frame brackets, each press frame bracket having a first end and a second end, wherein the first end is connected to the press frame; and
a plurality of structure frame brackets, each structure frame bracket having a first end and a second end; and
a plurality of tension devices.

15. The door assembly of claim 14, wherein the press frame is substantially the same shape as the doorframe.

16. The doorframe assembly of claim 14, wherein the press frame is substantially the same shape as the structure frame.

17. The doorframe assembly of claim 14, wherein the press frame is substantially the same shape as an innermost shape created by overlapping the doorframe with the structure frame.

18. The doorframe assembly of claim 14 wherein each of the press frame bracket first ends is substantially parallel to the plane of the door, and each of the press frame bracket second ends is substantially orthogonal to the plane of the door.

19. The doorframe assembly of claim 18 wherein each of the structure frame bracket first ends is substantially orthogonal to the plane of the door, and each of the structure frame bracket second ends is substantially parallel to the plane of the door.

20. The door assembly of claim 19 wherein each of tension devices is capable of initiating a tension between one of the structure frame bracket second ends and the structure frame, the tension having a vector component substantially relating to the direction of the press frame.
